(19) United States
(12) Patent Application Publication
(10) Pub. No.: US 2013/0032442 A1
(43) Pub. Date: Feb. 7, 2013

(54) Fluid Inerter

(71) Applicant: Robin Tuluie, Steeple Aston (GB)

(72) Inventor: Robin Tuluie, Steeple Aston (GB)

(73) Assignee: Lotus FI Team Limited, Enstone, Oxfordshire (GB)

(21) Appl. No.: 13/575,017

(22) PCT Filed: Jan. 25, 2010
(86) PCT No.: PCT/GB2010/000112

§ 371 Date: Oct. 3, 2012

(51) Int. Cl. B60G 13/16; F16F 7/10

(52) U.S. Cl. 188/378

(57) ABSTRACT

The present invention relates to the field of inerters such as those used in vehicle suspension systems to control or counteract dynamic spring forces. The present invention arises from a surprising discovery, based on lab testing of another hydraulic suspension device, that the inertia of the fluid in a feed line has a very significant inertia effect, magnified by the ratio of the piston diameter to the line diameter to the 4th power. As a consequence, sufficient inertial reaction may be provided by the inertance of fluid alone and in the absence of a mechanical flywheel arrangement. Thus according to one aspect of the invention, there is provided an inerter (10, 110) which comprises first and second mechanical terminals (11, 12, 116, 140) which are arranged to be movable, one relative to the other, subject to an inertial reaction, wherein at least a portion of the inertial reaction is provided by hydraulic fluid inertance means (36, 152). Preferably the hydraulic fluid inertance means provides the primary source of inertia capable of operating between the terminals. No contribution to inertial reaction is made by a flywheel or means for spinning a mass in response to terminal relative movement.

The present invention relates to the field of inerters such as those used in vehicle suspension systems to control or counteract dynamic spring forces.

Tuned mass dampers have been used by the Renault Formula 1 Team to offset the loss in grip that can be caused by dynamic suspension loads. As tyres deflect vertically there can be a loss in contact pressure of the tyre on the track surface. Tuned mass dampers essentially provided a sprung mass on the chassis which counteracts the vertical forces that the suspension exerts on the car, smoothing out the load disturbances at the tyre contact patch. Such a device was successfully used in Formula 1 cars until a regulation change.

In an alternative approach, inerters have been used in suspension systems to provide an inertial reaction which dynamically counteracts spring forces, such as suspension spring forces from coil or torsion springs. While inerters are less effective at smoothing out load disturbances at the tyre contact patch than tuned mass dampers, their inertial force can still be used to partially cancel net dynamic forces which would otherwise disturb the grip and handling of the car.

The principles underlying the use of inerters have been described by Malcom Smith in International patent application WO 2003/005142 A1. Dr Smith describes in schematic terms several mechanically different embodiments of inerters. An inerter of this type has been used previously in Formula One cars. The inerter is used in place of the transverse heave (or third) conventional damper, so that it operates when both left and right hand sides of the suspension are moving at the same time, rather than when the car is rolling (See for example Autosport, The Weekly Journal, Vol. 14, Issue 19, 7 May 2008).

This inerter and other similar inerters in use at present in motor vehicles involve a mechanical arrangement in which a screw threaded rod is located in a correspondingly threaded bore of a cylindrical flywheel mass to convert linear suspension travel to spinning of the flywheel mass.

US2009/0139225 discloses an inerter which by contrast uses a piston-driven hydraulic fluid to drive a gear mechanism which spins a flywheel. In this disclosure the hydraulically-driven flywheel provides the inertia. This disclosure does not recognise that the hydraulic fluid itself may exert an inertance and the equation describing the inertance of the system does not include any contribution of fluid inertia.

The present invention arises from a surprising discovery, based on lab testing of another hydraulic suspension device, that the inertia of the fluid in feed line has a very significant effect, magnified by the ratio of piston to line diameter to the 4^{th} power. Indeed it has been unexpectedly discovered that sufficient inertial reaction may be provided by the inertance of the hydraulic fluid alone and/or in the absence of a mechanical flywheel arrangement.

Thus according to one aspect of the invention, there is provided an inerter which comprises first and second mechanical terminals which are arranged to be movable one relative to the other subject to an inertial reaction, wherein at least a portion of the inertial reaction is provided by hydraulic fluid inertance means.

“Hydraulic fluid inertance means” concerns an arrangement in which the presence of a hydraulic fluid provides an inertance, where inertance is a measure of the fluid pressure which is required to bring about a change in fluid flow rate in a system. Between the terminals this translates to an inertial force which resists acceleration.

Hydraulic fluid is a fluid such as a liquid which is substantially incompressible. Typically the fluid will have a low viscosity. Examples include water, oils, heavy liquids (such as mercury) and more complex liquid formulations.

The hydraulic fluid inertance means should preferably provide the primary source of inertia reaction capable of operating in the inerter between the terminals. That is to say there may be incidental inertia reactions provided by other components or effects, either within or associated with the inerter, but the fluid inertance should provide most of the inertia reaction. Thus there is preferably no contribution to inertial reaction is made by means for spinning a (solid) mass in response to terminal relative movement.

The hydraulic fluid inertance means does not rely upon acting to spin a mass in response to terminal relative movement. By contrast it makes use of the fluid inertance in an elongate conduit (i.e. a fluid line) to provide an effective inertance.

The hydraulic fluid inertance means may comprise fluid displacement means disposed in a chamber for hydraulic fluid. The fluid displacement means will typically be connected (directly or indirectly) to one of the terminals. The chamber may be connected to the other terminal so that movement of one terminal relative to the other causes the displacement means to move relative to the chamber. In other words, the displacements means will act upon a fluid disposed in the chamber.

In another aspect of the invention, the hydraulic fluid inertance means comprises fluid path constriction means (preferably an elongate path) through which hydraulic fluid must flow to permit displacement of the displacement means. The constriction serves to magnify the inertance because the constriction has a smaller area than say the chamber cross-sectional area which is swept by the displacement means.

The fluid path constriction means preferably comprises at least one elongate liquid conduit in fluid communication with the chamber. In a preferred arrangement the elongate conduit discharges from a first region of the chamber and loops to feed back into a second region of the chamber. The fluid displacement means is disposed in the chamber and serves as a boundary between the first and second chamber regions. Thus hydraulic fluid discharged from one region by the displacement means shunts fluid through the elongate conduit back into the other region.

In a preferred arrangement at least a portion of the elongate conduit defines a tortuous fluid path. For example the path may include multiple loops, bends, switchbacks or coils which serve to compact the conduit whilst maintaining the effective fluid path length. Thus in one preferred embodiment a portion of the elongate conduit has a generally helical configuration. The coils may be helical (i.e. of constant radius) or may be oval or otherwise deviate from a pure helix. There may be multiple windings so that the coils are layered two or more deep. In a most preferred arrangement at least a portion of the conduit is coiled around the chamber. The coil preferably has a rotational axis which coincides with or is parallel with a direction of travel of the displacement means.

A relief valve may be provided in the conduit, wherein the relief valve is adapted to close the conduit until a threshold fluid pressure is reached, whereupon the flow path is opened until the pressure is released, thereby to provide a system damping effect. The relief valve may be provided in a pocket (e.g. a bulb or local expansion) formed in the conduit. Thus the pocket corresponds to a localised widening of the conduit cross sectional area. The relief valve may also terminate into a separate chamber to provide a means of fluid displacement due to thermal expansion.

In yet another aspect of the invention a liquid conduit bypass is provided which is adapted when active to reduce the effective conduit length and thereby reduce the inertance. This bypass may connect between any points of the liquid conduit, or across the fluid displacement means, or between any other connections accessing the hydraulic fluid.

In a preferred arrangement, the fluid displacement means comprises a piston, such as a piston plate. The piston may be fixed onto a rod, one distal end of which forms an inerter terminal. The chamber for hydraulic fluid may comprise a cylinder in which the piston is a sliding fit. The piston may be a close-tolerance fit to the bore or feature a sealing arrangement to the bore, such as one or more O-rings. The chamber may be defined by a housing which is connected to the other terminal.

At least one inertance relief valve may be provided which is adapted to open a relief flow path when a threshold fluid pressure or velocity is reached, thus making the valving a function of piston displacement, velocity, acceleration or frequency of operation. In one arrangement the inertance relief valve provides a relief path which bypasses the fluid displacement means. For example said inertance relief valve may have a relief path which communicates through the fluid displacement means between opposing sides thereof.

The relief valve may comprise a shim or a shim stack which in use is capable of deflecting from a closed position in which a relief path is closed or partially closed by a shim to an open position in which the shim lifts to open the relief path.

In yet a further aspect of the invention, there is provided an inerter as hereinbefore described, wherein no contribution to inertance is made by rotation of a solid mass or by a gear mechanism.

Preferably at least 50%, more preferably at least 75% and most preferably at least 90% (i.e. a large majority) of the inertial reaction between the terminals is provided by the hydraulic fluid inertance means.

In a still further aspect of the invention there is provided an inerter as hereinbefore described wherein a damper is provided between the terminals.

The present invention minimizes the use of moving parts and uses hydraulic fluid to provide the inertial reaction. Thus in one further aspect the invention provides an inerter in which no contribution to inertial reaction is made by a flywheel.

The inerter may be used in any mechanical system in which dynamic loads need to be resisted. The inerter finds particular application in a suspension system for a motor land vehicle which includes one or more inerter as hereinbefore described. Other applications will however be within the comprehension of the skilled person.

In accordance with another aspect of the invention the inerter is configured and arranged to be capable of providing an inertia reaction in the range of 10 to 500 kg, which is a typical range required in Formula One racing cars. The mass of fluid in the fluid conduit (or fluid constriction) may be from 1 to 50 g of fluid in the line.

The invention also provides novel uses. So in one aspect the invention provides, in an inerter, the use of an hydraulic fluid as the primary source of inertance. The invention also provides, in an inerter, the use of an hydraulic fluid as the source of inertance wherein there is no contribution to inertial reaction by a flywheel or a gear train.

A preferred fluid is mercury, which has low viscosity but a high mass.

Following is a description by way of example only and with reference to the figures of the drawings of ways of putting the present invention into effect.

In the drawings:—

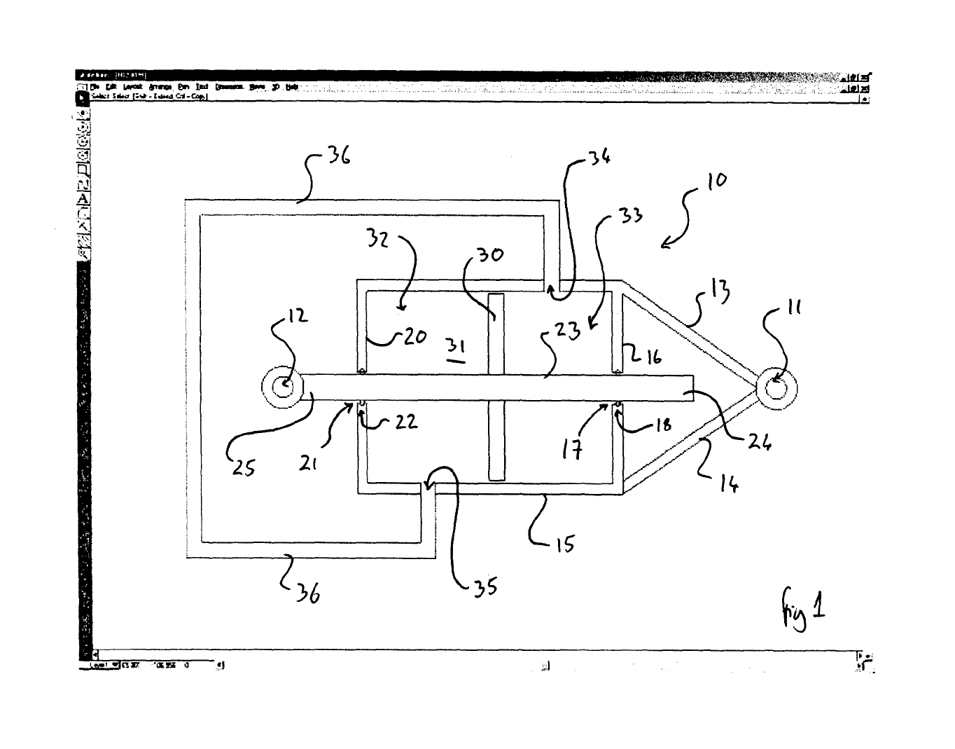

FIG. 1 is a cross-sectional schematic representation of an inerter according to a first embodiment of the invention.

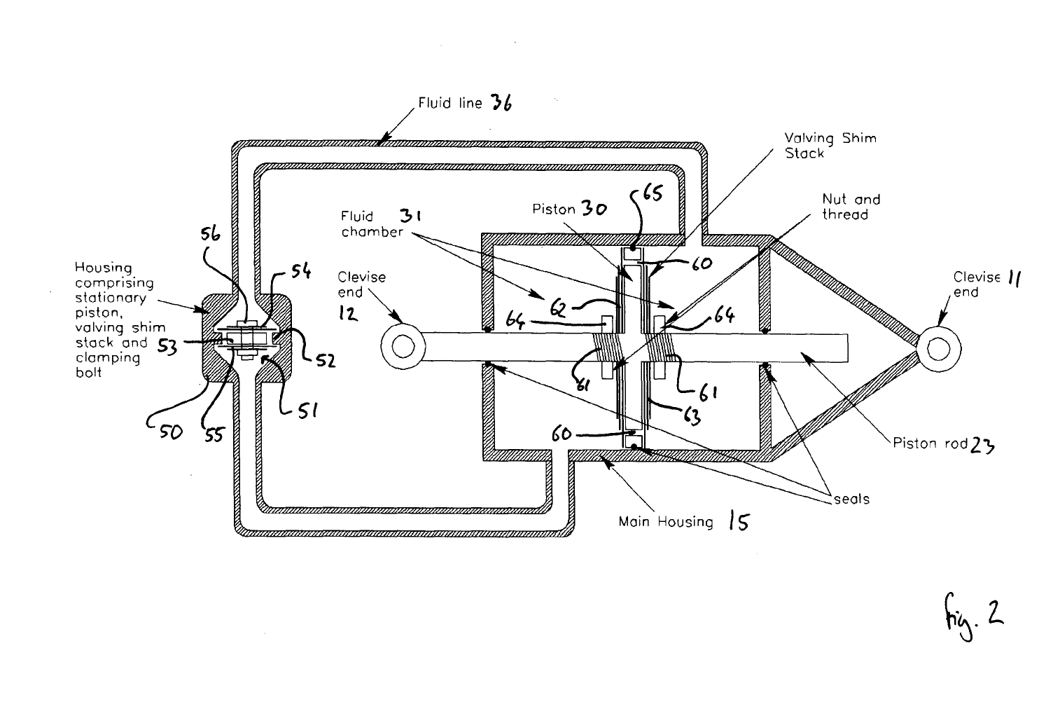

FIG. 2 is a cross-sectional schematic representation of an inerter according to a second embodiment of the invention.

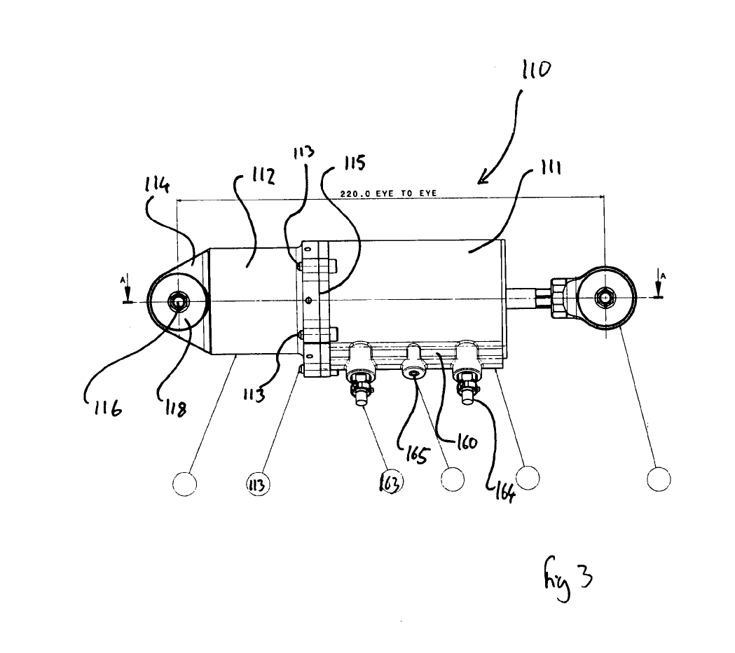

FIG. 3 is a side view of an inerter according to a third embodiment of the invention.

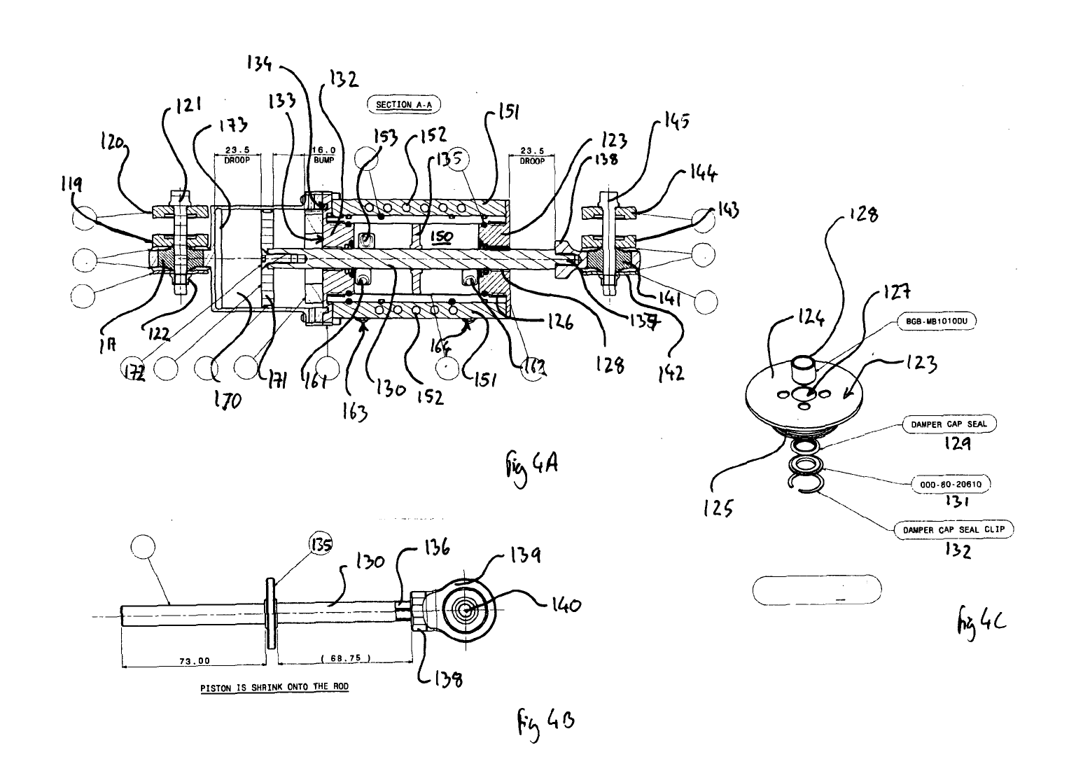

FIG. 4A is a longitudinal cross section along the line A-A shown in FIG. 3.

FIG. 4B is side view of a piston and rod used in the inerter of FIGS. 3 and 4A.

FIG. 4C is a perspective exploded view of an end cap used in the inerter of FIGS. 3 and 4A.

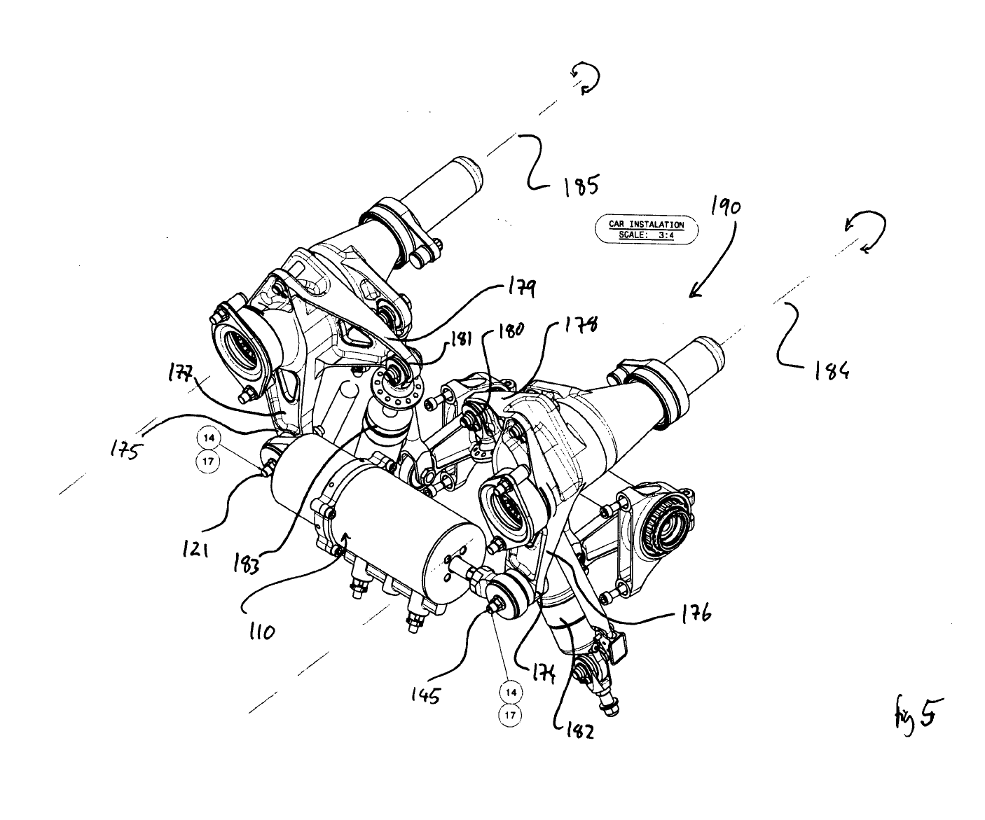

FIG. 5 is a perspective view of a portion of a Formula 1 racing car's suspension system, showing the inerter of FIGS. 3 and 4A in situ.

### FIRST EMBODIMENT

In FIG. 1 an inerter is shown generally as 10. First and second eyelets 11,12 serve as mechanical terminals which allow the inerter to be incorporated into a suspension system (for which see FIG. 2C). The first eyelet 11 is connected via struts 13,14 to a cylindrical housing 15. The housing has a first circular end wall 16 which is formed with an axial bore 17. The bore is formed with an inner recess in which is seated a seal ring 18. A second circular end wall 20 is provided at an opposite end of the housing and is similarly formed with an axial bore 21 and seal ring 22. A circular-section elongate rod 23 is a sliding fit in the bores 17, 21. First and second end regions 24,25 of the rod project beyond the respective first and second housing end walls. The rod second end region is provided with the second eyelet 12. A mid region of the shaft carries a circular piston plate 30 which is fixed on the rod. The piston plate is a sliding fit in the internal cylindrical cavity 31 defined by the housing 15.

The rod and attached second eyelet may be moved relative to the housing and first eyelet in an axial direction of travel. Such travel causes the piston plate to move in the internal cavity of the housing. The internal cavity is divided into left and right hand chambers 32, 33 by the piston plate. An upper sidewall region of the housing to the right of the piston plate is formed with a port 34. A lower sidewall region of the housing to the left of the piston plate is formed with a port 35. An elongate circular section fluid line 36 extends between the ports 34, 35.

The housing chambers 32, 33 and line 36 are filled with an hydraulic fluid, which is preferably liquid mercury. Travel of the shaft in the axial direction causes the piston plate to displace fluid from one chamber into the other through the line. This fluid has a mass and will therefore exert an inertial force (or reaction) back onto the piston.

A fluid inertia in the fluid line varies as the square of the surface area of the piston relative to the cross sectional area of the line (i.e. as the 4^{th} power of diameter for cylindrical lines). Thus for a piston diameter of 40 mm, and a line diameter of 4 mm, the inertance is (40/4)⁴=10,000 times larger than the mass of the fluid in the line. Hence inertances in the range of 10 to 500 kg, which is a typical range required in Formula One racing cars, can be easily realized with only 1 to 50 g of fluid in the line.

Unlike flywheel-based inerters, the inerter of the present invention has, with the exception of the piston, rod and fluid, no moving parts. It thus may be expected to be more reliable, easier and less expensive to manufacture, and easier to assemble in a production environment. In addition it has a safe failure mode in that unlike a flywheel there are no spinning surfaces or bearings to lock-up. The inerter will require less maintenance than ball-screw, gear or flywheel-based devices and it can operate in water spray or in dust without need for the additional sealing that mechanical (i.e. non-hydraulic) inerters need. The absence of a flywheel makes the device lighter and for some applications more compact.

The piston and plunger arrangement is a similar structure to a conventional damper and it is therefore easy to combine an inerter together with a conventional damper in an integral device.

The inerter of the present invention has the potential for better performance as compared to a mechanical inerter or hydraulically driven flywheel inerter due to the absence of backlash. Backlash is harmful because it causes additional force disturbances which can be detrimental to tyre grip.

A further advantage is that the inertance can easily be adjusted by means of lengthening or shortening the fluid line or conduit, or by bypassing a portion of the line/conduit, or by changing the fluid line diameter, or by changing the density of the fluid.

When incorporated into a suspension system the fluid inerter of the present invention has an inertial force which is essentially:
a. Proportional to the acceleration of the piston relative to the housing
b. Proportional to the square of the surface area ratio between the piston and the line
c. Proportional to the mass of the fluid in the line.
d. 180 degrees out of phase to the spring force, thus cancelling dynamic spring force variations.

Furthermore, the fluid inerter of the invention produces a damping force which is 90 degrees out of phase with the spring force, in accordance with typical dampers, but employing a stationary damper piston.

In use the rod is displaced by the action of the suspension as a reaction to a bump from the road. Rod causes the piston to shift in the cylinder. The piston (area Aₚᵢₛₜₒₙ) exerts a pressure on the fluid, which causes the fluid to flow through the line, which has an area Aₗᵢₙₑ. The fluid, according to the laws of physics, resists this motion with a damping force and an inertial force.

The inertial force acting on the piston (and shaft) is equal to:

Fᵢₙₑᵣₜᵢₐₗ=a_{rod}*m_{fluid}*(Aₚᵢₛₜₒₙ/Aₗᵢₙₑ)²

Where a(rod) is the acceleration of the shaft (and piston) relative to the housing and m (fluid) is the mass of the fluid in the line.

Given enough fluid mass m (or line length), sufficient inertial force can be generated so this device acts as an inerter.

A small amount of inertial force is also generated by the mass of the shaft and piston itself; however, for all practical purposes this force is much smaller than the fluid inerter component once the area ratio of piston and line is sufficiently large. In addition, this shaft/piston force is not a true inerter—because, while of inertial origin, the inertial force of the piston and shaft is not due to the relative acceleration of the piston/shaft with respect to the housing; instead, it is due to the absolute acceleration of the shaft/piston relative to the world. Inerters are 2-point functions and only produce force due to the acceleration of two points moving relative to each other. Inertia is due to one point accelerating relative to the world.

Inerters are devices of specific design, while inertia is present in everyday life, for every object. Inertia is usually not helpful in suspensions, whereas inerters are very useful, as explained in WO 2003/005142 A1.

One advantage of the fluid inerter of the invention is that it can be retrofitted into a vehicle in the same position that is usually occupied by the suspension damper. Unlike mechanical inerters, which still require a separate damper in the suspension, the fluid inerter does not need an extra lever (rocker) to drive it.

The fluid inerter requires no pre-charge or fluid reservoir, nor will its performance deteriorate with increasing pressure or temperature (within some limits), in contract to mechanical flywheel inerters which are subject to tribological wear and heat generation.

Fluid of different density can be used to adjust inertance. Thus a high mass fluid such as mercury may be used to provide high inertance. A lower mass fluid such as mineral oil may be used to provide less inertance. Similarly, fluid of different viscosities can be used to adjust the inherent damping effect.

### SECOND EMBODIMENT

FIG. 2 shows a second embodiment of the invention which is effectively a modification of the embodiment shown in FIG. 1. Common features have therefore been given common reference numbers. In FIG. 2 the fluid line 36 extends via a housing 50 which is formed with a flared cylindrical chamber or pocket 51. The chamber is provided with an annular ridge portion 52 and a piston plate 53. Alternatively, the chamber 51 is provided with a stationary restriction or piston plate 53, attached to or integral to the housing 50. Upper and lower shims stacks 54,55 are bolted to the piston plate by bolt 56 which passes through a piston plate bore. The shims each comprise an annular disc. By stacking shims of suitable size the resilience of the stack may be tuned to provide a desired response. The outer circumference of a base shim covers an annular spacing between the rim and piston plate. Thus the fluid flow path is blocked by the shim, until lifting or fluttering of the shim under fluid pressure, or under dynamic load allows fluid to flow past.

If the shims are not present, or if the shims are deflected by the force of the moving fluid, the wall and hole create a reduced damping effect, similar to that of a conventional damper. If the shims are present, they serve to amplify the damping effect at low fluid speed, while at higher fluid speed the shims are deflected out of the way and the damping is regulated by the hole size. Different versions of such regulating orifices are possible. The concept of the hydraulic fluid inerter allows for a very simple integration of inerter and damper elements together using the same fluid to give inertance as well as damping, with the minimum moving parts.

The piston plate 30 which is carried on the rod 23 in this second embodiment is formed with one or more circumferential ports 60 and a circumferential O-ring seal 65. A region of the rod one each side of the piston plate is formed with a screw thread 61. Annular shim discs are placed on either side of the piston plate to create a shim stack 62,63 on each side. In the drawing each stack is made up of three shims of gradually increasing diameter approaching the piston. The shim closest the piston has a similar diameter to the piston plate itself. Thus the closest shim overlaps and obturates the ports 60. Screw threaded nuts 64 are used to urge the shims against the piston, whilst permitting the outer edge of the shims to flex away from the piston surface. The shims further away from the piston surface constrain the closest shim and thus increase shim stack rigidity.

With a hole and shim stack present through the piston plate this may be used to fine-tune inertance. If the shims are not present, or if the shims are deflected by the force of the moving fluid, the holes create a loss of inertance (reduction of fluid inertia) as fluid can bypass the piston without flowing through the lines. Some incidental damping will also occur as a result of the fluid bypassing past the shim stack and through the piston holes.

Thus this regulating device can be used to:
(1) reduce the inertance of the device at some desirable fluid velocities,
(2) reduce the inertance of the device at some desirable fluid accelerations,
(3) reduce the inertance of the device at some desirable rod motions/displacements (this can also be achieved via a bypass through the walls of the housing—see embodiment 3).
(4) reduce the inertance of the device as some desirable shaft frequencies (if frequency-sensitive regulating devices are used within the piston and shim stack).

One such frequency-sensitive device (but not the only one) involves the use of shims with appreciable mass or a piston plate 53 (in FIG. 2) of appreciable mass, which will start to flutter at some frequency. Such devices are known in conventional dampers, but have not to the inventor's knowledge been used heretofore in inerters.

The present embodiment provides a damping force that is adjustable depending on choices of fluid line diameter, line length and piston area. In this case, adjustments to damping will lead to changes in inertance and vice versa.

The damping force may be adjustable via insertion of a small diameter and very short orifice-type restrictor or valve. In this case an adjustment in orifice damping will have no affect on the inertance.

The damping force may be adjustable via insertion of a stationary damping piston, which has a tune-able performance due to the shim-stack design of conventional dampers, but unlike conventional dampers, this piston is not moving.

### THIRD EMBODIMENT

Having generally described the invention with respect to the schematic figures, the following specific embodiment provides detailed instructions for putting the invention into effect. An inerter according to invention is shown as 110 in FIG. 3. The inerter has an elongate, generally cylindrical housing formed in two cylindrical facing portions 111,112. The two housing portions are joined together at an abutment 115 by five circumferentially spaced apart bolts 113.

A distal end region of the left hand housing 111 is formed with a tapered bracket 114. The bracket is formed with a transverse eyelet bore 116. The bore accommodates a spherical bearing 117 (visible in FIG. 4A). An annular plate 118 is placed over the bearing and constrains the bearing in the bore. A far side of the bracket abuts an annular spacer collar 119. A second spacer collar 120 is disposed transversely spaced apart from the first. A bolt 121 passes through the collars 119,120, bearing 117 and constraint plate 118 and is retained by a nut 122.

The right side of the right hand housing portion 112 is provided with an end cap 123. The end cap is shown in more detail in FIG. 4C. The end cap has a circular top plate 124 and an annular threaded plug 125 which engages with a corresponding threaded seat 126 in the housing (see FIG. 4A). The end cap is formed with a central axial bore 127. The bore is formed with a recess in which is disposed a bush sleeve 128. A ring seal 129, seal seat 131 and C-clip 132 are disposed in a stepped annular recesses formed in the housing side of the end cap bore. A circular-section elongate axial plunger rod 130 passes through the bore and seal 129 and rests on the bush's (128) inner surface as a sliding fit therein. A corresponding bored end cap 132 closes the opposite end of the right hand hosing. This end cap has a top plate 133 which is formed with an annular surface recess 134.

The plunger rod is supported between the bushes of the two end caps 123,132 and is capable of sliding left and right. The plunger rod is shown in isolation in FIG. 4B. A circular plunger plate 135 is fixed to a middle region of the rod. The fixing is made by shrink fitting to form a tight friction fit or by retention using circlips or nuts.

A right hand end 136 of the plunger rod is formed with a screw-threaded spigot 137 which engages with a correspondingly screw threaded flange member 138. The flange member has a right hand distal region which is formed as a collar 139. The collar has a central eyelet 140 which carries a spherical bearing 141. A lower side of the bearing is retained by an annular plate 142. An upper side of the bearing abuts a spacer collar 143. A further spacer collar 144 is spaced apart and above the first collar 143. A bolt 145 passes through the collars 143,144, bearing 141 and plate 141 and is retained by a nut.

The cylindrical right hand housing portion 112 defines an internal cylindrical cavity 150. The cavity receives the plunger plate as a sliding fit therein, as shown in FIG. 4A. The plunger plate divides the cavity 150 into left and right hand chambers. The housing portion 111 has a cylindrical sidewall 151 which is formed with an internal helical bore 152. As an alternative construction (not shown) housing 151 comprises an inner sleeve and an outer sleeve, where one sleeve has U-section grooves machined into a surface thereof, and the other sleeve provides the seal against the ridges between grooves of the first sleeve. The grooves can of course be machined into an outer surface of the inner sleeve, or into an inner surface of the outer sleeve. The bore has a first end which feeds into the cavity at an inner sidewall tapered recess 153. The second end of the bore feeds into the cavity at another tapered recess (not visible in FIG. 4A). The first and second feeds are disposed at opposite end regions of the cavity, with the plunger plate 135 disposed therebetween.

The sidewall is formed with an axially extending bypass bore 160 which is shown in FIG. 3. The bore is provided at first and second ends thereof with radially extending feed bores. Each of these feed bores communicates with the bypass bore and feeds into the cavity at tapered recesses 161, 162 (visible in FIG. 4A). Outside ends of the bores stand proud of the housing as stub pipes 163, 164. Each of these stub pipes is provided with a valve which permits selective draining or charging of the cavity 150 with hydraulic fluid. A central region of the bypass bore is crossed by a radially extending valve member 165, which may be rotated to close or open the bypass bore.

The left hand housing portion 112 defines a cylindrical internal cavity 170 in which is accommodated a circular end stop plate 171. The end stop plate is attached to an end face of the plunger rod by means of a countersunk screw 172. The end stop plate serves to provide a travel limit to the device in full extension. A rubber bump stop 173 serves to cushion the end stop contact of end stop plate 171 against the end cap 133. The end stop plate is a sliding fit and travels axially in the cavity 170 on the plunger rod 130.

The right hand housing portion cavity 150 is charged via stub pipe 163 (with 164 venting displaced air) with hydraulic fluid, preferably a high mass incompressible liquid, such as mercury. The liquid fills both chambers either side of the plunger plate and the helical bore 152.

The left hand eyelet 116 serves as one terminal of the inerter and the right hand eyelet 140 serves as the other terminal. The inerter occupies the site of a traditional heave damper or heave spring or heave rubber endstop, in a generally transverse orientation, as shown in the suspension system 190 shown in FIG. 5. It may also occupy other locations within the suspension of the car, such as the corner dampers, or the roll damper, depending on the suspension layout of the car. The eyelets are attached via the eyelet bolts 121,145 to end regions 174,175 of depending suspension arm brackets 176,177. Inwardly extending arm brackets 178,179 are themselves connected to upper terminals 180,181 of upright angled dampers 182,183. When vehicle in which the suspension system is provided passes over a bump the suspension recoils. The inward arms are forced downwards and rotate about the shafts axes 184,185 (shown in FIG. 5) causing the depending arms 176,177 to rotate outwards and extend the inerter 110 axially between its terminals. The acceleration of the inerter plunger plate towards the right hand side tends to shunt fluid from one chamber via the helical bore to the other chamber. Because the bore has a fraction of the cross sectional area of the plunger plate (or cavity) the system has a very large fluid inertance. The fluid inertance (I) of the system may be represented as

I=(ρA_{bore}*L_{bore})*(Aₚᵢₛₜₒₙ/A_{bore})²=ρ*L_{bore})*(Aₚᵢₛₜₒₙ)²/A_{bore}
Where ρ=fluid density, L_{bore}=bore (or line) length, A_{bore}=bore cross sectional area and Aₚᵢₛₜₒₙ is the piston cross sectional area, which is equal to the housing 152 internal bore area minus the piston rod 130 area.

Hence the inertance is proportional to bore length and fluid density, and is inversely proportional to the area of the bore. The cavity 150 also has an inertance, but will be considerably less than that provided by the bore because the cross section area is much larger and the cavity length is less somewhat less than the helical bore area. The bore can if desired be bypassed by opening valve 165. This allows fluid to flow axially through the bypass bore (or line) between the chambers on either side of the plunger plate. This reduces the length of the active bore (as compared to the helical bore) and thus the fluid inertance is reduced.

The damper portion of the inerter within housing 111 and bore 152 may be tuned to provide a desirable level of damping, thereby obviating the need for a separate heave damper.

While this device was invented to aid the handling and grip of a Formula One car, it is clear that it will have applications to other vehicles and other fields of technology. For example, one could envision this device being usable to control hydraulic resonances in actuators, or reduce dynamic spring forces in machinery, while still offering the same static spring support.

The scope of protection is defined in the claims hereinafter.

1. An inerter (10,110) which comprises first and second mechanical terminals (11,12,116,140) which are arranged to be movable one relative to the other subject to an inertial reaction, wherein at least a portion of the inertial reaction is provided by hydraulic fluid inertance means (36, 152, 30,31,135).

2. An inerter as claimed in claim 1 wherein the hydraulic fluid inertance means provides the primary source of inertial reaction capable of operating between the terminals (11,12,116,140).

3. An inerter as claimed in claim 1 or claim 2 wherein no contribution to inertial reaction is made by means for spinning a mass in response to terminal relative movement.

4. An inerter as claimed in any of the preceding claims wherein the hydraulic fluid inertance means is not capable of acting to spin a solid mass in response to terminal relative movement.

5. An inerter as claimed in any of the preceding claims wherein the hydraulic fluid inertance means comprises fluid displacement means (30,135) disposed in a chamber (31,150) for hydraulic fluid.

6. An inerter as claimed in claim 5 wherein the fluid displacement means is operatively connected to one of the terminals (12,140) and a chamber housing (15,151) is operatively connected to the other terminal (11,116) so that movement of one terminal relative to the other causes the displacement means (30,135) to move relative to the chamber (31,150).

7. An inerter as claimed in claim 5 or claim 6 wherein the hydraulic fluid inertance means comprises fluid path constriction means (36,152) through which hydraulic fluid must flow to permit displacement of the displacement means.

8. An inerter as claimed in claim 7 wherein the fluid path constriction means comprises at least one elongate liquid conduit (36,152) in fluid communication with the chamber.

9. An inerter as claimed in claim 8 wherein the elongate conduit (36,152) discharges from a first region (34 or 35) of the chamber and loops to feed back into a second region (35 or 34) of the chamber with the fluid displacement means (30,135) disposed in the chamber between the said first and second regions so that hydraulic fluid discharged from one region shunts fluid through the elongate conduit back into the other region.

10. An inerter as claimed in claim 8 or claim 9 wherein at least a portion (152) of the elongate conduit defines a tortuous path.

11. An inerter as claimed in claim 10 wherein the tortuous path has a generally helical configuration.

12. An inerter as claimed in claim 10 or claim 11 wherein the said portion of the elongate conduit is coiled or wrapped within or around a chamber wall (151), or a housing which contains the chamber.

13. An inerter as claimed in any of claims 8 to 12 wherein in at least a portion of the conduit is coiled around the chamber.

14. An inerter as claimed in any of claims 8 to 13 wherein a relief valve (50,51,52,53,54,55) is provided in the conduit, wherein the relief valve is adapted to close the conduit until a threshold fluid pressure is reached, whereupon the flow path is opened to release a proportion of the pressure, thereby to provide a system damping effect.

15. An inerter as claimed in claim 14 wherein the relief valve is provided in a pocket (51) formed in the conduit, which pocket corresponds to a localised widening of the conduit cross sectional area.

16. An inerter as claimed in any of claims 8 to 15 wherein a liquid conduit bypass (160) is provided which is adapted when active to reduce an effective fluid path length thereby to reduce the inertance.

17. An inerter as claimed in any of claims 5 to 16 wherein the fluid displacement means comprises a piston (30,135).

18. An inerter as claimed in claim 17 wherein the chamber for hydraulic fluid comprises a cylinder (15,151) in which the piston (30,135) is a sliding fit.

19. An inerter as claimed in any of the preceding claims wherein at least one relief valve (60,62,63) is provided which is adapted to open a relief flow path when a threshold fluid inertance is reached.

20. An inerter as claimed in claim 19 wherein the inertance relief valve provides a relief path (60) which bypasses the fluid displacement means (30).

21. An inerter as claimed in claim 20 wherein said inertance relief valve has a relief path (60) which communicates through the fluid displacement means (30) between opposing sides thereof.

22. An inerter as claimed in any of claims 19 to 21 wherein the relief valve comprises a shim or a shim stack (62,63) which is capable of deflecting under fluids pressure from a closed position in which a relief path is closed or partially closed by a shim to an open position in which the shim lifts to open the relief path (60).

23. An inerter as claimed in any of the preceding claims wherein no contribution to inertance is made by rotation of a solid mass or by a gear mechanism.

24. An inerter as claimed in any of the preceding claims wherein the majority of the inertial reaction between the terminals is provided by the hydraulic fluid inertance means.

25. An inerter as claimed in any of the preceding claims wherein a damper is provided between the terminals.

26. An inerter according to any preceding claim wherein no contribution to inertial reaction can be made by a flywheel.

27. A suspension system (190) for a motor land vehicle which includes one or more inerters according to any of the preceding claims.

28. A motor land vehicle including a suspension system according to claim 27.

29. In an inerter, the use of an hydraulic fluid inertance as the primary source of inertial reaction.

30. In an inerter, the use of an hydraulic fluid inertance as the source of inertial reaction wherein there is no contribution to inertial reaction by a flywheel.
